(19) United States
(12) Patent Application Publication
(10) Pub. No.: US 2012/0119896 A1
(43) Pub. Date: May 17, 2012

(54) SYSTEMS AND METHODS FOR INFORMING A USER A PRESENCE OF A SUBJECT IN A VEHICLE

(76) Inventors: Ben LAM, San Francisco, CA (US); Chi T. TRAN, San Francisco, CA (US); Kelly LAM, San Francisco, CA (US)

(21) Appl. No.: 12/944,685

(22) Filed: Nov. 11, 2010

(51) Int. Cl. B60Q 1/00

(52) U.S. Cl. 340/457

(57) ABSTRACT

An apparatus for reminding a user that there is a subject in a vehicle includes a sensor, an warning device, an electrical connector configured to couple to a cigarette adaptor outlet in a vehicle for receiving power therefrom, and a circuit coupled to the electrical connector, wherein the circuit is configured to activate the warning device when the sensor senses a subject in a vehicle, and when there is a lack of power from the cigarette adaptor outlet. A method of operating a warning device of a system that is configured to sense a subject in a vehicle, includes sensing a lack of power from a cigarette adaptor outlet in the vehicle, sensing the subject in the vehicle, and activating the warning device in response to the lack of power from the cigarette adaptor outlet in the vehicle and the sensed subject in the vehicle.

### FIELD

This application relates generally to vehicle accessories, and more particularly, to systems and methods for reminder a user that there is a presence of a subject in a vehicle.

### BACKGROUND

Driver and/or passenger of a vehicle sometimes like to place a baby or other objects, such as a purse, a laptop, a cell phone, etc., in the vehicle. Applicant of the subject application determines that sometimes the driver and/or the passenger may forget to pick up the baby or other objects from the vehicle as the driver and/or the passenger is leaving the vehicle. Thus, Applicant of the subject application determines that it would be desirable to have a system and a method for detecting a presence of a subject in a vehicle.

### SUMMARY

In accordance with some embodiments, an apparatus for reminding a user that there is a subject in a vehicle includes a sensor, an warning device, an electrical connector configured to couple to a cigarette adaptor in a vehicle for receiving power therefrom, and a circuit coupled to the electrical connector, wherein the circuit is configured to activate the warning device when the sensor senses a subject in a vehicle, and when there is a lack of power from the cigarette adaptor.

In accordance with other embodiments, an apparatus for reminding a user that there is a subject in a vehicle includes a sensor for sensing a force or a pressure, a warning device, an electrical connector configured to couple to a cigarette adaptor outlet in a vehicle for receiving power therefrom, and a circuit coupled to the electrical connector, wherein the circuit comprises a relay switch that closes in response to a lack of power from the cigarette adaptor outlet to thereby cause power to be delivered from a battery to the warning device.

In accordance with other embodiments, a method of operating a warning device of a system that is configured to sense a subject in a vehicle, includes sensing a lack of power from a cigarette adaptor in the vehicle, sensing the subject in the vehicle, and activating the warning device in response to the lack of power from the cigarette adaptor in the vehicle and the sensed subject in the vehicle.

In accordance with other embodiments, a method of operating a warning device of a system that is configured to sense a subject in a vehicle, includes sensing power from a cigarette adaptor in the vehicle, and de-activating the warning device in response to the sensed power from the cigarette adaptor in the vehicle.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a system for detecting a presence of a subject in a vehicle in accordance with some embodiments;

FIG. 2 illustrates the circuit of FIG. 1 in accordance with some embodiments;

FIG. 3A illustrates a method performed by the circuit of FIG. 1 in accordance with some embodiments;

FIG. 3B illustrates another method performed by the circuit of FIG. 1 in accordance with other embodiments;

FIG. 4 illustrates a system for detecting a presence of a subject in a vehicle in accordance with other embodiments;

FIG. 5 illustrates a system for detecting a presence of a subject in a vehicle in accordance with other embodiments; and

FIG. 6 illustrates a system for detecting a presence of a subject in a vehicle in accordance with other embodiments.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

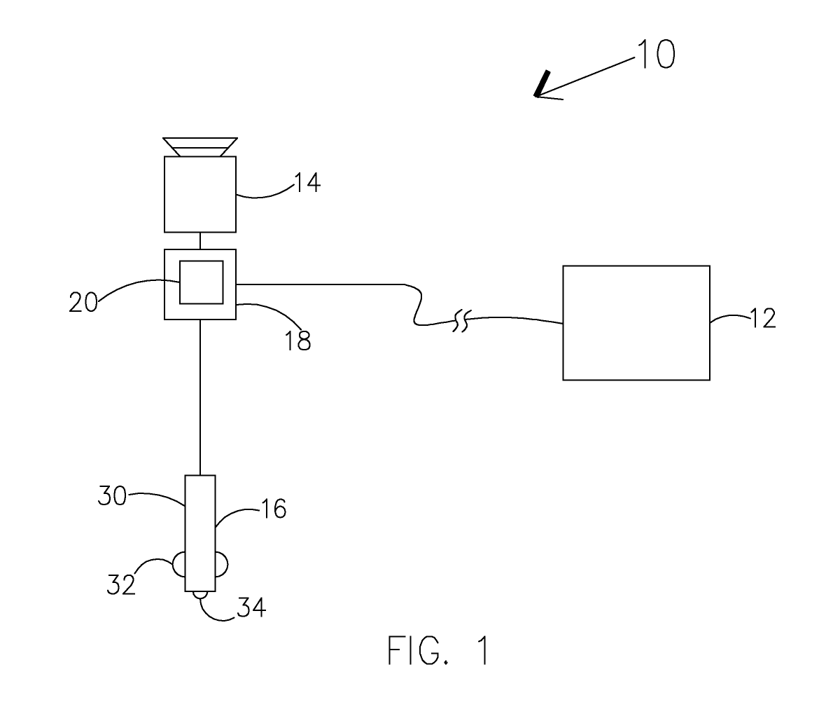

FIG. 1 illustrates a system 10 for detecting a presence of a subject in a vehicle in accordance with some embodiments. By means of non-limiting examples, the subject may be a passenger (such as an infant, a toddler, a patient, an elderly, etc.,) or an object (such as a purse, a laptop, a cell phone, etc.). As used in this specification, the term “vehicle” is not limited to a car, and may refer to a vehicle that travels in the sea (such as a boat, a vessel, etc.), or a vehicle that travels in the air (such as a plane, a jet, etc.).

The system 10 includes a sensor 12, a warning device 14, a connector 16, and a circuit 18. The sensor 12 is configured to sense a presence of a subject in a vehicle, and the connector 16 is configured to sense power (or lack thereof) from a cigarette adaptor of the vehicle. The circuit 18 is configured to activate or de-activate the warning device 14 based at least on certain pre-determined conditions that are governed by the state of the sensor 12 (e.g., whether the sensor 12 is activated or not based on a presence or absence of a subject) and the state of the cigarette adaptor (e.g., whether there is power at the cigarette adaptor or not). The system 10 further includes a power source 20 (e.g., a battery or batteries) for operating the sensor 12 and/or the warning device 14. In some embodiments, the power source 20 may be considered as a part of the circuit 18.

In the illustrated embodiments, the sensor 12 comprises a switch that may be actuated in response to a force or pressure being applied thereto. In some cases, the sensor 12 may be implemented as a force/pressure sensor that is configured to sense a pressure or a force. As used in this specification, a force sensor or a pressure sensor may be any switch that is configured to be actuated in response to a force or pressure. In some embodiments, the sensor 12 is configured to sense a magnitude of the force or pressure being applied thereto. In other embodiments, the sensor 12 does not determine any magnitude of the force or pressure, but is simply activated when a force or pressure of sufficient magnitude is applied to the sensor 12 to activate a switch in the sensor 12. The sensor 12 may be a pad that has a planar configuration in some embodiments. In other embodiments, the sensor 12 may have other configurations, e.g., shapes, sizes, etc. The pad 12 may be placed above or underneath a seat, such as an infant car seat, a booster seat, or the car seat, during use.

Also, in the illustrated embodiments, the warning device 14 is an audio device that is configured to emit an audio signal. The audio signal may be one or more beeps, may be in the form of music, or may be in the form of a self-recorded message. In other embodiments, the system 10 may further include a volume control (not shown) for adjusting a volume of the audio signal. For example, the volume control may be on the warning device 14. Alternatively, the volume control may be implemented on the connector 16. In other embodiments, if the system 10 has a separate housing for containing the circuit 18, the volume control may be implemented at the circuit housing. In some cases, the volume control cannot be used to mute the warning device 14, so that the warning device 14 remains operational to warn the user.

In the illustrated embodiments, the connector 16 comprises a cigarette adaptor that is configured to detachably couple to a cigarette adaptor outlet in a vehicle. In particular, the connector 16 has an elongate housing 30 with a first terminal 32 at a side of the housing 30 and a second terminal 34 at an end of the housing 30. The elongate housing 30 is sized to be inserted into an opening of the cigarette adaptor outlet at a vehicle. The first and second terminals 32, 34 are configured to make electrical contact with respective terminals at the cigarette adaptor outlet when the connector 16 is inserted into the cigarette adaptor outlet.

In the illustrated embodiments, the circuit 18 is coupled to the connector 16, and is configured to activate or de-activate the warning device 14 based on certain pre-determined conditions. In particular, in a first mode of operation, the circuit 18 is configured to activate the warning device 14 (e.g., to cause the warning device 14 to emit a warning signal) when the circuit 18 receives a signal from the sensor 12 indicating a presence of a subject in the vehicle, and when there is a lack of power from a cigarette adaptor outlet of the vehicle to the circuit 18. In some embodiments, the circuit 18 may be configured to activate the warning device 14 by sending a signal to the warning device 14. In other embodiments, the circuit 18 may be configured to activate the warning device 14 by closing a switch (e.g., relay) that allows power to be delivered to the warning device 14 to thereby activate the warning device 14. The relay may be implemented as part of the circuit 18 or the warning device 14 in some embodiments.

In a second mode of operation, the circuit 18 is configured to de-activate the warning device 14 (e.g., to cause the warning device 14 to stop emitting a warning signal) when the circuit 18 does not receive a signal from the sensor 12 indicating a presence of a subject in the vehicle, or when the circuit 18 senses that there is power being delivered from the cigarette adaptor outlet of the vehicle to the circuit 18. In some embodiments, the warning device 14 may be considered “de-activated” if the circuit 18 prevents the warning device 14 from being activated, if the circuit 18 does not activate the warning device 14, or if the circuit 18 switches the warning device 14 from an activated state to an un-activated state. Thus, the term “de-activate” or similar term does not necessarily require the warning device 14 to be initially “ON”, and should not be limited to turning off a warning device 14 that is initially “ON.”

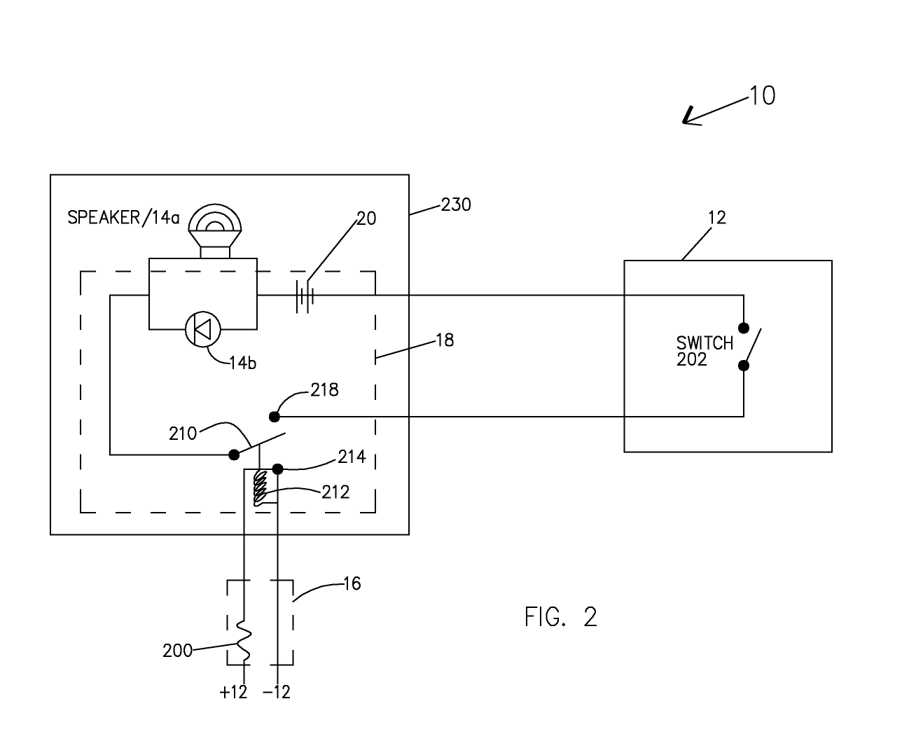

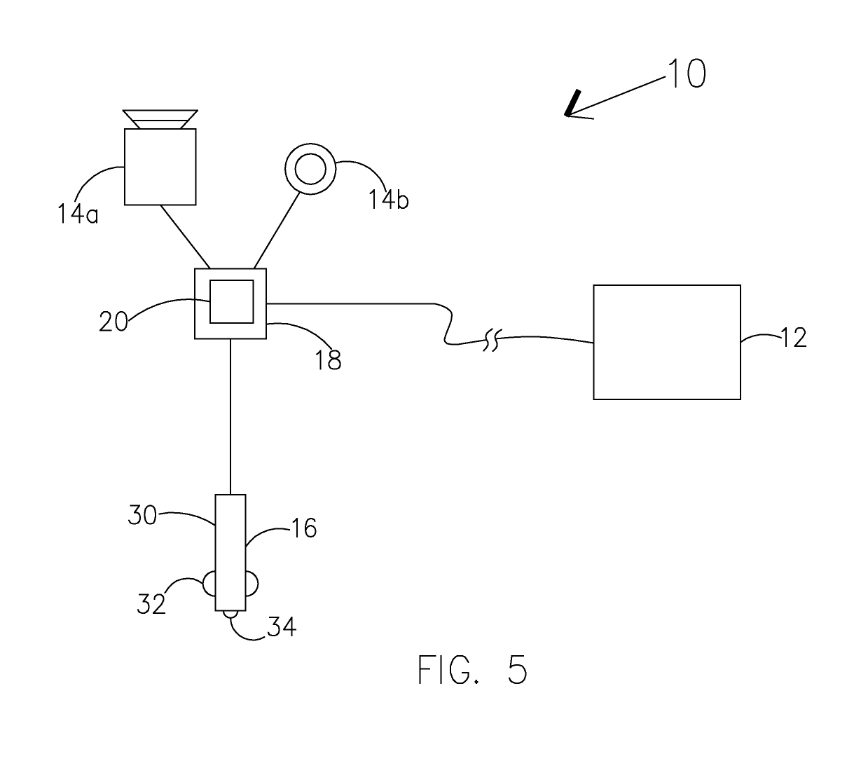

FIG. 2 illustrates an implementation of the system of FIG. 1, particularly showing the circuit 18 in accordance with some embodiments. As shown in the figure, the connector 16 has a built-in fuse 200 which protects the detection system 10. The sensor 12 includes a switch 202 which will close in response to a force or pressure applied to the sensor 12. The circuit 18 includes a relay switch 210 that may open or close, depending on whether there is power being received by the connector 16. The circuit 18 also includes a terminal 214, and a terminal 218 coupled to the sensor 12. In the illustrated embodiments, the system 10 further includes a housing 230 to which the circuit 18 and the warning device 14 are coupled. As shown in the figure, the fuse 200 of the connector 16 is connected to a coil 212. When the car ignition is at the “off” position, the coil 212 will not energize. Therefore, the relay switch 210 and terminal 218 will remain in contact. When a subject is placed on the sensor 12, the switch 202 of the sensor 12 will close, which will complete the circuit. In this event, the circuit 18 will cause power to be delivered from the battery 20 to the speaker 14a (which may be an example of the warning device 14 described previously), thereby activating the speaker 14a. When the ignition of the vehicle is “on”, the relay/coil 212 is energized, causing the relay switch 210 to separate from terminal 218, and to come in contact with the terminal 214, thereby creating an open circuit. In this event, the circuit 18 does not allow power to be delivered from the battery 20 to the speaker 14a, and the speaker 14a will not be activated. In the figure, the system 10 optionally further includes a light source (e.g., LED) 14b, which activates together with the activation of the speaker 14a, or de-activates together with the de-activation of the speaker 14b. The light source 14b provides a visual signal for reminder the user that there is a subject in the vehicle. The embodiment of the system 10 that includes two warning devices 14a, 14b will be further discussed below with reference to FIG. 5. It should be noted that the circuit 18 should not be limited to the configuration shown, and that the circuit 18 may have different configurations in other embodiments, as long as it can perform any of the functions described herein. Also, in some embodiments, the circuit 18 may be implemented using a processor, such as a general processor, an ASIC processor, or a FPGA processor. Thus, the circuit 18 may be implemented using hardware, software, or combination of both.

It should be noted that although components 12, 14, 16, 18 are illustrated as separate components, in other embodiments, any of these components may be combined. For example, in other embodiments, the warning device 14 may be implemented as part of the connector 16. In such cases, the connector 16 may include a speaker for emitting audio signals. In other embodiments, the circuit 18 may be contained within the housing of the connector 16, and may be implemented as a part of the connector 16 or vice versa. In further embodiments, the circuit 18 may be implemented as a part of the warning device 14 or vice versa. In still further embodiments, the warning device 14, the connector 16, and the circuit 18 may be implemented as a unit. For example, the housing of the connector 16 may contain the circuit 18 and the warning device 14.

During use of the system 10, the connector 16 of the system 10 is inserted into the cigarette adaptor outlet of a vehicle, so that the terminals 32, 34 of the connector 16 are in electrical contact with respective terminals at the cigarette adaptor outlet. Also, the sensor 12 may be placed above or underneath a seat, such as an infant seat. The sensor 12 may then be used to support (either directly or indirectly) any subject, such as a baby, a purse, a laptop, a cell phone, etc.

In the illustrated embodiments, the vehicle is configured to provide power to the cigarette adaptor outlet when the vehicle's ignition is on, and stop providing power to the cigarette adaptor outlet when the ignition is off. Thus, assuming that the ignition of the vehicle is initially off, when the connector 16 is inserted into the cigarette adaptor outlet of the vehicle, and after the subject is supported by the sensor, the circuit 18 will sense no power from the cigarette adaptor outlet, and will receive a signal from the sensor 12 indicating that there is a presence of a subject in the vehicle. Accordingly, the circuit 18 will cause the warning device 14 to emit a warning signal. For example, the circuit 18 may send a signal (e.g., power) to the warning device 14 to activate the warning device 14. Alternatively, the circuit 18 may include a switch (such as a relay) that closes to provide electrical power from the power source 20 to the warning device 14 to activate the warning device 14 in response to lack of power from the cigarette adaptor. The activation of the warning device 14 causes the warning device 14 to emit a warning signal to inform the user that there is a subject in the vehicle. Thus, the act of activating the warning device 14 may be accomplished actively (e.g., by sending a signal to the warning device 14), or passively, (e.g., by closing a switch in response to a detected power from the cigarette adaptor outlet) by the switch 18.

Next, the user of the system 10 may turn on the ignition of the vehicle. The ignition of the vehicle causes power to be supplied to the cigarette adaptor outlet. Accordingly, the circuit 18, which is coupled to the cigarette adaptor outlet, will sense that there is power from the cigarette adaptor outlet. Since the circuit 18 is configured to de-activate the warning device 14 upon a detection of power from the cigarette adaptor outlet, when the ignition of the vehicle is turned on, the circuit 18 will cause the warning device 14 to be de-activated. For example, the circuit 18 may send a signal (which may be a null signal/power, or an actual signal, for examples) to the warning device 14 to de-activate the warning device 14. Alternatively, the circuit 18 may include a switch (such as a relay) that opens to stop providing electrical power from the power source 20 to the warning device 14 to de-activate the warning device 14 in response to the detected power from the cigarette adaptor. Thus, the act of de-activating the warning device 14 may be accomplished actively (e.g., by sending a signal to the warning device 14), or passively, (e.g., by opening a switch to prevent power from being delivered to the warning device 14) by the circuit 18. In the illustrated embodiments, the warning device 14 will stay de-activated as long as there is power provided at the cigarette adaptor outlet of the vehicle (e.g., as long as the vehicle's ignition is on to provide the power to the cigarette adaptor outlet).

Next, when the driver of the vehicle reaches a destination, the driver may turn off the ignition of the vehicle. When this happens, power is no longer provided to the cigarette adaptor outlet. The circuit 18 will sense no power from the cigarette adaptor outlet, and will receive a signal from the sensor 12 indicating that there is a presence of a subject in the vehicle. Accordingly, the circuit 18 will cause the warning device 14 to emit a warning signal, warning the user that there is a subject in the vehicle. In some embodiments, the warning signal stays on for a prescribed period of time (e.g., 30 seconds). In other embodiments, the warning signal stays on indefinitely until the subject supported above the sensor 12 is removed.

As illustrated in the above embodiments, the system 10 is beneficial because it provides a warning to the driver to remind the driver that there is a subject (such as a baby, a purse, a laptop, a cell phone, etc.) in the vehicle that needs to be removed. The system 10 is configured to provide such warning when the vehicle's ignition is turned off, which is the desirable time to provide such warning because when a driver turns off a vehicle, there is a risk that the driver may leave the vehicle forgetting to pick up the subject in the vehicle. On the other hand, when the vehicle's ignition is on, the risk of having the driver leaves the vehicle is low. Also, the system 10 is advantageous because it can be provided as an aftermarket accessory that is “plug-and-play” without any modification to the original configuration of the vehicle. Furthermore, because the system 10 uses the power (or lack thereof) from the cigarette adaptor outlet as a surrogate for determining whether the vehicle's ignition is on or off, the use of the system 10 does not require complicated sensor connected to the ignition system of the vehicle for determining a state of the ignition system.

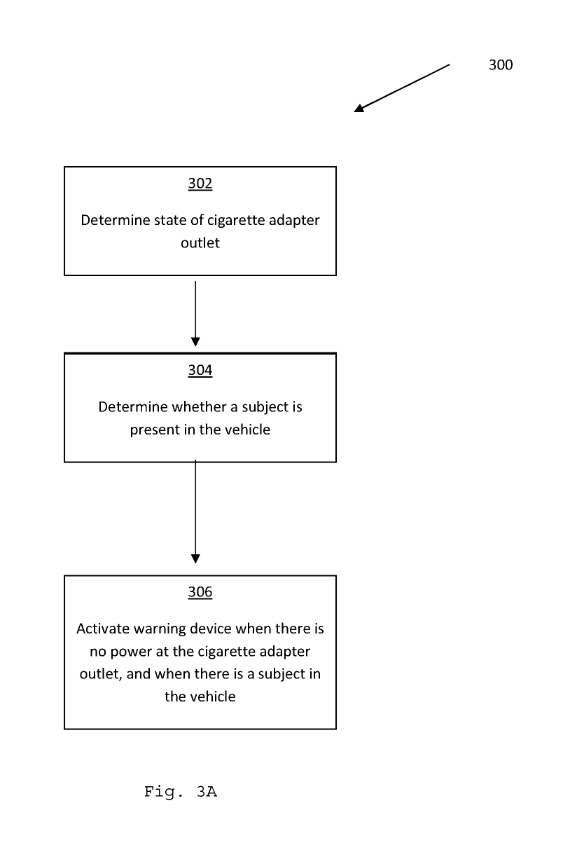

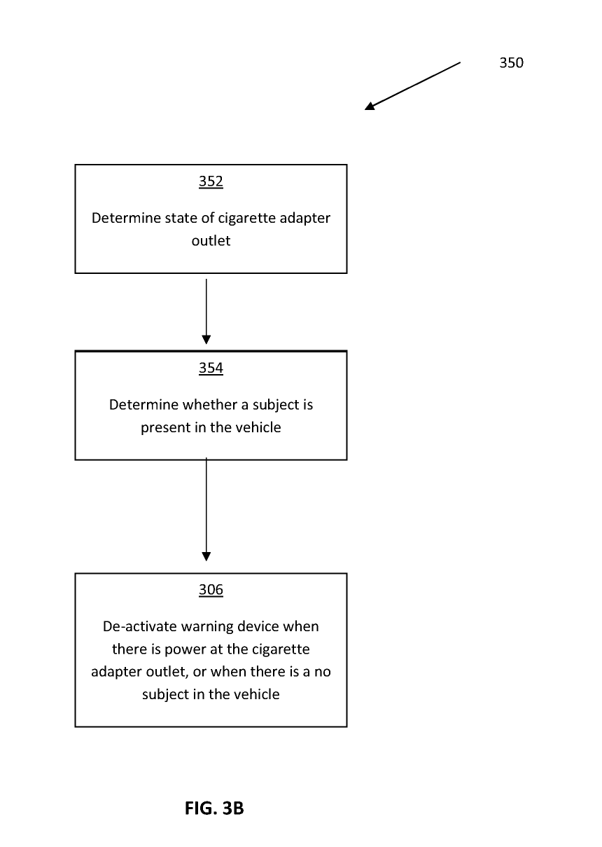

As discussed, the circuit 18 is configured to activate the warning device 14 when the sensor 12 senses a subject in the vehicle and when there is lack of power at the cigarette adaptor outlet of the vehicle. FIG. 3A illustrates a method 300 performed by the circuit 18 of the system 10 in accordance with some embodiments. First, a state of a cigarette adaptor outlet in a vehicle is determined (step 302). In some embodiments, the circuit 18 may determine that the cigarette adaptor outlet is in an inactive state because there is no power being supplied from the cigarette adaptor outlet. Such may be accomplished by sensing no power (lack of power) from the cigarette adaptor outlet. For example, the connector 16 may receive no power from the cigarette adaptor outlet, and transmit no signal (e.g., power signal) to the circuit 18. When the circuit 18 receives no signal from the connector 16, the circuit 18 then determines that the cigarette adaptor outlet is in an inactive state. Next, the circuit 18 determines whether there is a presence of a subject in the vehicle (step 304). In some embodiments, the circuit 18 may determine that there is a presence of a subject in the vehicle. Such may be accomplished by the circuit 18 receiving a signal from the sensor 12 indicating that there is a presence of a subject in the vehicle. When the sensor 12 senses a presence of a subject in the vehicle, and when there is a lack of power from the cigarette adaptor outlet, the circuit 18 then activates the warning device 14 to warn the user that there is a subject in the vehicle (step 306).

In any of the embodiments described herein, the sensor 12 is configured to determine if a sensed force or pressure by the sensor 12 is above a prescribed threshold, and if it is above the prescribed threshold, then the sensor 12 will send a signal to the circuit 18 indicating a presence of a subject in the vehicle. Alternatively, the sensor 12 is configured to send a signal regardless of the magnitude of the sensed force or pressure, and the circuit 18 is configured to determine if the sensed force or pressure is above the prescribed threshold. If the sensed force or pressure is above the prescribed threshold, then the circuit 18 will determine that there is a presence of a subject in the vehicle. In either case, a force or a pressure may be considered to be sensed by the sensor 12, and the subject in the vehicle is considered to be sensed, if the magnitude of the force or pressure is above the prescribed threshold. Such configuration is beneficial because it will prevent the system 10 from detecting subject that is too light. In other embodiments, such feature is not included, and the sensor 12 is configured to send a signal to the circuit 18 when it senses a force or pressure, regardless of its magnitude. In such cases, the circuit 18 is configured to determine that there is a subject in the vehicle as long as the magnitude of the sensed force or pressure is above zero. In further embodiments, the subject is considered sensed when a switch in the sensor 12 is activated.

Also as discussed, the circuit 18 is configured to de-activate the warning device 14 when the sensor 12 senses no subject in the vehicle, or when there is power at the cigarette adaptor outlet of the vehicle. FIG. 3B illustrates another method 350 performed by the circuit 18 of the system 10 in accordance with other embodiments. First, a state of a cigarette adaptor outlet in a vehicle is determined (step 352). In some embodiments, the circuit 18 may determine that the cigarette adaptor outlet is in an active state because it is providing power.

Such may be accomplished by sensing power from the cigarette adaptor outlet. For example, the connector 16 may receive power from the cigarette adaptor outlet, and transmit a signal (e.g., power signal) to the circuit 18. When the circuit 18 receives the signal from the connector 16, the circuit 18 then determines that the cigarette adaptor outlet is in an active state. Next, the circuit 18 determines whether there is a presence of a subject in the vehicle (step 354). In some embodiments, the circuit 18 may determine that there is no subject in the vehicle that is being sensed by the sensor 12. Such may be accomplished by the circuit 18 receiving no signal (or by the circuit 18 receiving a null signal) from the sensor 12, or by the circuit 18 receiving a signal from the sensor 12 that is below a prescribed threshold, indicating that there is no subject sensed by the sensor 12 in the vehicle. When the sensor 12 senses no subject in the vehicle, or when there is power from the cigarette adaptor outlet, the circuit 18 then de-activates the warning device 14 (step 356). As discussed herein, the act of de-activating the warning device 14 may be accomplished actively (e.g., by sending a signal to the warning device 14 to de-activate it), or passively, (e.g., by opening a switch to prevent power from being delivered to the warning device 14) by the switch 18.

In any of the embodiments described herein, the sensor 12 is configured to determine if a sensed force or pressure by the sensor 12 is below a prescribed threshold, and if it is below the prescribed threshold, then the sensor 12 will not send a signal to the circuit 18, thereby indicating an absence of a subject in the vehicle. Alternatively, the sensor 12 is configured to send the signal to the circuit 18 regardless of the magnitude of the sensed force or pressure, and the circuit 18 is configured to determine that there is no subject if the magnitude of the sensed force or pressure is below the prescribed threshold. In either case, a force or a pressure is considered to be not sensed by the sensor 12 or the circuit 18 if the sensed force or pressure is below the prescribed threshold. Such configuration is beneficial because it will prevent the system 10 from detecting subject that is too light. In other embodiments, such feature is not included, and the sensor 12 is configured to send a signal to the circuit 18 when it senses a force or pressure, regardless of its magnitude. In such cases, the circuit 18 is configured to determine that there is a subject in the vehicle as long as the magnitude of the sensed force or pressure is above zero. In further embodiments, the sensor 12 is considered as not sensing any subject if a switch in the sensor 12 is not activated.

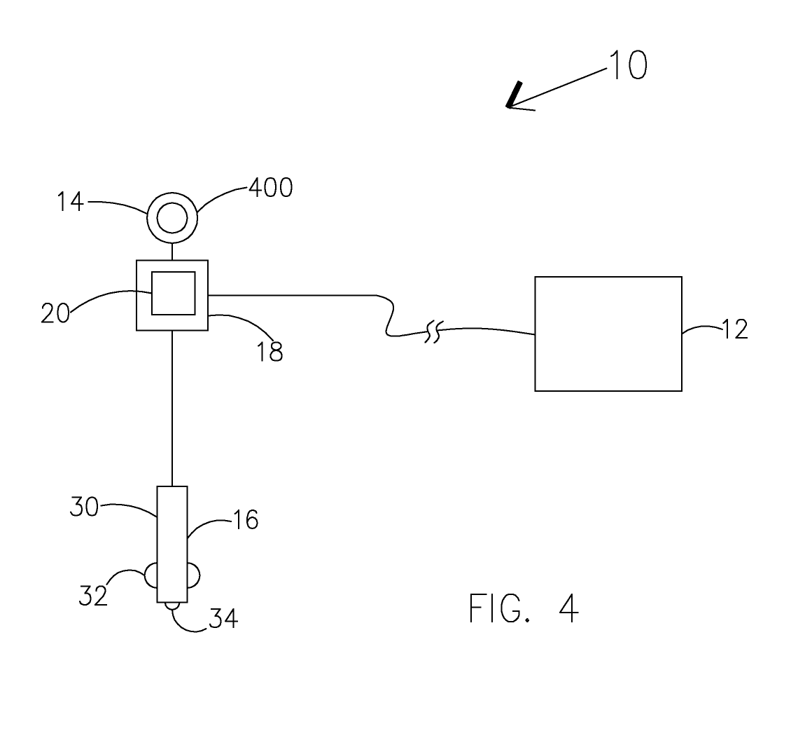

In the above embodiments, the warning device 14 is described as an audio device configured to emit an audio signal for warning a user that there is a subject in the vehicle. In other embodiments, instead of being an audio device, the warning device 14 may be an optical device 400 (FIG. 4). For example, the warning device 14 may include one or more light emitting devices, such as one or more light bulbs, one or more LEDs, or a LCD screen, for emitting light signal(s). In such cases, the warning device 14 is configured to emit light as a warning signal to warn the user that there is a subject in the vehicle. In a first mode of operation, the circuit 18 is configured to activate the optical warning device 14 (e.g., one or more light sources) when it senses that there is a lack of power being delivered from the cigarette adaptor outlet, and when it receives a signal from the sensor 12 indicating a presence of a subject in the vehicle. In a second mode of operation, the circuit 18 is configured to de-activate the optical warning device 14 (e.g., one or more light sources) when it senses that there is power being delivered from the cigarette adaptor outlet, or when there is no signal from the sensor 12 indicating a presence of a subject in the vehicle. In some embodiments, the warning device 14 may be considered “de-activated” if the circuit 18 prevents the warning device 14 from being activated, if the circuit 18 does not activate the warning device, or if the circuit 18 switches the warning device 14 from an activated state to an un-activated state. Thus, the term “de-activate” or similar term does not necessarily require the warning device 14 to be initially “ON”, and should not be limited to turning off a warning device 14 that is initially “ON.”

In other embodiments, the warning device 14 may include different light sources that emit different respective colors of light. In such cases, in a first mode of operation, the circuit 18 is configured to activate the optical warning device 14 (e.g., one or more light sources that emit a first color light, such as red light) when it senses that there is a lack of power being delivered from the cigarette adaptor outlet, and when it receives a signal from the sensor 12 indicating a presence of a subject in the vehicle. In a second mode of operation, the circuit 18 is configured to activate the optical warning device 14 (e.g., another one or more light sources that emit a second color light, such as green light) when it senses that there is power being delivered from the cigarette adaptor outlet, or when there is no signal from the sensor 12 indicating a presence of a subject in the vehicle.

Using an optical device to emit a warning signal is advantageous because in some cases in which the subject is a baby, the baby may be asleep when the driver of the vehicle turns off the ignition. In such cases, the warning device 14 will emit a light signal (i.e., instead of an audio signal) to warn the driver so that the baby will not be waken up by any audio signal. Also, in some cases, the optical device may allow a user who may be hearing-impaired to use the system 10, and/or may allow a user to easier notice the warning signal at night time.

In further embodiments, the warning device 14 of the system 10 may include both an audio device 14a and an optical device 14b for providing respective warning signals to a user (FIG. 5). The audio device 14a may be any of the embodiments of the audio device described herein, and the optical device 14b may be any of the embodiments of the optical device described herein. In such cases, in a first mode of operation, the circuit 18 is configured to activate both the audio device 14a and the optical device 14b when it senses that there is a lack of power being delivered from the cigarette adaptor outlet, and when it receives a signal from the sensor 12 indicating a presence of a subject in the vehicle. In a second mode of operation, the circuit 18 is configured to de-activate both the audio device 14a and the optical device 14b when it senses that there is power being delivered from the cigarette adaptor outlet, or when there is no signal from the sensor 12 indicating a presence of a subject in the vehicle. In some embodiments, the warning device 14 may be considered “de-activated” if the circuit 18 prevents the warning device 14 from being activated, if the circuit 18 does not activate the warning device, or if the circuit 18 switches the warning device 14 from an activated state to an un-activated state. Thus, the term “de-activate” or similar term does not necessarily require the warning device 14 to be initially “ON”, and should not be limited to turning off a warning device 14 that is initially “ON.”

Providing both an audio device 14a and the optical device 14b for warning a user that there is a subject left in the vehicle is advantageous. This is because it provides extra warning to the user. In particular, if the user misses the audio signal from the audio warning device 14a (e.g., this may due to the user not paying attention to the audio signal), the user may notice the visual signal provided by the optical device 14b. Similarly, if the user misses the optical signal from the optical warning device 14b (e.g., this may due to the user not paying attention to the optical signal), the user may notice the audio signal provided by the audio device 14a.

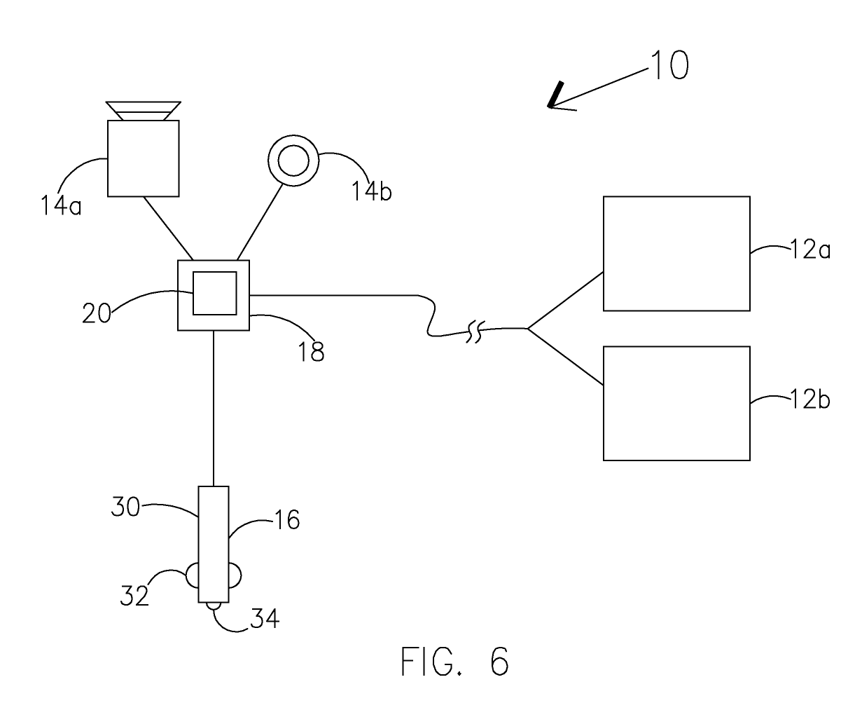

In any of the embodiments described herein, the system 10 may include a plurality of sensors 12 (FIG. 6). In the illustrated embodiments, the system 10 includes two sensors 12a, 12b. However, in other embodiments, the system 10 may include more than two sensors 12. Also, in the illustrated embodiments, the warning device 14 may be any of the embodiments of the warning device 14 described herein. For example, the warning device 14 may be an audio device, an optical device, or combination of both. Providing a plurality of sensors 12 is advantageous because it allows the system 10 to detect more than one subject in the vehicle. For example, if a family has two babies, then the two sensors 12a, 12b may be placed underneath two respective child seats in the vehicle. In such cases, in a first mode of operation, the circuit 18 is configured to activate the warning device 14 when it senses that there is a lack of power from the cigarette adaptor outlet, and when it receives a signal from one or both of the sensors 12a, 12b, indicating that there is one or two subjects in the vehicle. In a second mode of operation, the circuit 18 is configured to de-activate the warning device 14 when it senses that there is power from the cigarette adaptor outlet, or when the circuit 18 does not receive any signal from both the sensors 12a, 12b. In some embodiments, the warning device 14 may be considered “de-activated” if the circuit 18 prevents the warning device 14 from being activated, if the circuit 18 does not activate the warning device, or if the circuit 18 switches the warning device 14 from an activated state to an un-activated state. Thus, the term “de-activate” or similar term does not necessarily require the warning device 14 to be initially “ON”, and should not be limited to turning off a warning device 14 that is initially “ON.”

Another benefit of providing two (or more) sensors 12a, 12b is that they can be used to simultaneously sense a presence of a live subject (such as a baby) and an object (such as a purse, a laptop, a cell phone, etc.). In such cases, if the user forgets to pick up one or both of the live subject and the object upon turning off the ignition of a vehicle, the system 10 will warn the user.

In the above embodiments, the sensor 12 and the warning device 14 are illustrated as being physically coupled (e.g., by one or more wires) to the circuit 18. In other embodiments, the sensor 12 may be communicatively coupled to the circuit 18 wirelessly. In such case, the circuit 18 may include a wireless receiver for receiving a signal from the sensor 12, wherein the signal is for indicating a presence of a subject in the vehicle. Alternatively, or additionally, in other embodiments, the warning device 14 may be communicatively coupled to the circuit 18 wirelessly. In such case, the circuit 18 may further include a wireless transmitter for transmitting a signal to the warning device 14 for activating or de-activating the warning device 14.

Also, in any of the embodiments described herein, the warning device 14 may be implemented using the speaker(s) of the vehicle. In such cases, the circuit 18 may be configured to be coupled to the circuit of the vehicle for accessing the speaker(s) of the vehicle. In further embodiments, the system 10 may include a radio frequency tuner for channeling an audio alert signal from the warning device 14 to the car speaker(s).

Furthermore, although embodiments of the system 10 have been described as being used with a vehicle that stops providing power to the cigarette adaptor outlet when the ignition of the vehicle is turned off, in other embodiments, the system 10 may be used with other vehicles having other configurations. For example, in other embodiments, the vehicle may still provide power to the cigarette adaptor outlet after the vehicle's ignition is turned off. In such cases, the cigarette adaptor outlet will continue to provide power until the door (e.g., the driver's door) of the vehicle is opened. Embodiments of the system 10 may be used with vehicles having such configuration. This is because when the ignition is off, and when the door of the vehicle is opened, it is likely that the driver is about to leave the vehicle. In such cases, embodiments of the system 10 will provide warning to the user if there is a subject in the vehicle.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. An apparatus for reminding a user that there is a subject in a vehicle, comprising:
a sensor;
an warning device;
an electrical connector configured to couple to a cigarette adaptor outlet in a vehicle for receiving power therefrom; and
a circuit coupled to the electrical connector;
wherein the circuit is configured to activate the warning device when the sensor senses a subject in a vehicle, and when there is a lack of power from the cigarette adaptor outlet.

2. The apparatus of claim 1, wherein the circuit is also configured to de-activate the warning device when the sensor does not sense the subject in the vehicle, or when there is power from the cigarette adaptor outlet.

3. The apparatus of claim 1, wherein the sensor comprises a pressure sensor or a force sensor.

4. The apparatus of claim 1, wherein the warning device is configured to emit an audio signal in a form of music, one or more beeps, or a personalized message.

5. The apparatus of claim 1, wherein the warning device comprises an audio device, the apparatus further comprising a control electrically coupled to the audio device for adjusting a volume of an audio signal.

6. The apparatus of claim 1, wherein the electrical connector comprises an elongate housing, a first terminal at a side of the housing, and a second terminal at an end of the housing.

7. The apparatus of claim 1, further comprising an additional sensor coupled to the circuit.

8. The apparatus of claim 1, wherein the sensor is connected to the circuit by at least a first wire, and the warning device is connected to the circuit by at least a second wire.

9. The apparatus of claim 1, wherein the sensor is communicatively coupled to the circuit wirelessly.

10. The apparatus of claim 1, wherein the warning device is communicatively coupled to the circuit wirelessly.

11. The apparatus of claim 1, wherein the circuit comprises a relay switch that closes in response to the lack of power from the cigarette adaptor outlet to thereby cause power to be delivered from a battery to the warning device.

12. The apparatus of claim 1, wherein the warning device comprises an audio device, the apparatus further comprising an optical device for emitting a light signal, and wherein the circuit is configured to activate the optical device when the sensor senses the subject in the vehicle, and when the circuit detects the lack of power from the cigarette adaptor outlet.

13. An apparatus for reminding a user that there is a subject in a vehicle, comprising:
a sensor for sensing a force or a pressure;
a warning device;
an electrical connector configured to couple to a cigarette adaptor outlet in a vehicle for receiving power therefrom; and
a circuit coupled to the electrical connector;
wherein the circuit comprises a relay switch that closes in response to a lack of power from the cigarette adaptor outlet to thereby cause power to be delivered from a battery to the warning device.

14. The apparatus of claim 13, wherein the circuit is configured to activate the warning device when the sensor senses the force or the pressure, and when there is the lack of power from the cigarette adaptor outlet.

15. The apparatus of claim 13, wherein the circuit is configured to de-activate the warning device when the sensor senses no force or pressure, or when there is power from the cigarette adaptor outlet.

16. The apparatus of claim 13, wherein the warning device comprises an audio device, the apparatus further comprising an optical device for emitting a light signal, and wherein the circuit is configured to activate the optical device when the sensor senses the force or the pressure, and when the circuit detects the lack of power from the cigarette adaptor outlet.

17. A method of operating a warning device of a system that is configured to sense a subject in a vehicle, comprising:
sensing a lack of power from a cigarette adaptor outlet in the vehicle;
sensing the subject in the vehicle; and
activating the warning device in response to the lack of power from the cigarette adaptor outlet in the vehicle and the sensed subject in the vehicle.

18. The method of claim 17, further comprising de-activating the warning device when either there is power from the cigarette adaptor outlet, or when the subject in the vehicle is no longer sensed.

19. A method of operating a warning device of a system that is configured to sense a subject in a vehicle, comprising:
sensing power from a cigarette adaptor outlet in the vehicle; and
de-activating the warning device in response to the sensed power from the cigarette adaptor outlet in the vehicle.

20. The method of claim 19, wherein the warning device is de-activated regardless of whether there is a subject in the vehicle or not.
